(19) United States
(12) Patent Application Publication
(10) Pub. No.: US 2024/0160751 A1
(43) Pub. Date: May 16, 2024

(54) ENCRYPTING ACCESS TO DIGITAL ASSETS WITHOUT STORING SENSITIVE SECURITY DATA FOR DECRYPTION

(71) Applicant: Nicolas Leoutsarakos, Montreal (CA)

(72) Inventor: Nicolas Leoutsarakos, Montreal (CA)

(21) Appl. No.: 17/988,614

(22) Filed: Nov. 16, 2022

(51) Int. Cl. G06F 21/60; G06F 21/31; G06F 21/62

(52) U.S. Cl. CPC G06F 21/602; G06F 21/31; G06F 21/6209

(57) ABSTRACT

An encryption key created from sensitive security data is sourced from one or more functions. The sensitive security data is live data retrieved in real-time from a user context. A function describes a live data requirement (e.g., fingerprint, IP address, MAC address, router identification, iris detection, voice detection, and the like). The digital asset is then encrypted with the encryption key, from the sensitive security data, for storage. The encryption key with the sensitive security data is deleted. A decryption key is later generated with sensitive security data using the one or more indicators of the one or more functions to obtain an instance of live data in real-time from a current user context. The digital asset is decrypted with the decryption key, from current sensitive security data, for access to the digital asset. The decryption key with the sensitive security data is deleted.

### FIELD OF THE INVENTION

The invention relates generally to digital assets and security of digital assets, and more specifically, for encrypting access to digital assets, without storing sensitive security data for decryption.

### BACKGROUND

Standard encryption algorithms use a secure key for encrypting and decrypting files, photos, documents, logins, and other valuable information. The key is stored for use in decryption, typically a reverse algorithm of encryption. Unfortunately, hackers discover keys and use them to unlock valuables online.

What is needed is a robust technique for encrypting access to digital assets, without storing sensitive security data for decryption.

### SUMMARY

To meet the above-described needs, methods, computer program products, and systems are provided for encrypting access to digital assets, without storing sensitive security data for decryption.

In one embodiment, a request is received to protect a digital asset, and at a later point in time, a request is received for access to the same digital asset. An encryption key can be created from sensitive security data sourced from one or more functions. The sensitive security data is live data retrieved in real-time from a user context. A function describes one or more live data requirements. The digital asset is then encrypted with the encryption key derived from the sensitive security data, for storage.

In another embodiment, the encryption key with the sensitive security data is deleted. Instead, one or more indicators of the one or more functions related to the encryption key are stored in association with the digital asset. No sensitive security data is stored, and in a preferred embodiment, is destroyed, deleted, disabled, trashed, quarantined, or otherwise rendered useless. A decryption key is later generated with sensitive security data using the one or more indicators of the one or more functions to obtain instances of live data in real-time from a current user context. The digital asset is decrypted with the decryption key, from current sensitive security data, for access to the digital asset.

Advantageously, digital assets are better protected against hacking.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system for encrypting access to digital assets, without storing sensitive security data for decryption, according to one embodiment.

FIG. 2 is a more detailed block diagram illustrating a digital asset server of the system of FIG. 1, according to one embodiment.

FIG. 3 is a high-level flow diagram illustrating a method for protecting access to digital assets, according to one embodiment.

FIG. 4 is a more detailed flow diagram illustrating a step of encryption without storing sensitive security data, from the method of FIG. 3, according to one embodiment.

FIG. 5 is a more detailed flow diagram illustrating a step of decryption without locally stored sensitive security data, from the method of FIG. 3, according to one embodiment.

FIG. 6 is a flow diagram illustrating details of a key creation step of the method of FIG. 5, according to an embodiment.

FIG. 7 is a block diagram illustrating a computing device for the system of FIG. 1, according to one embodiment.

### DETAILED DESCRIPTION

Methods, computer program products, and systems for using unsupervised machine learning to derive thresholds for encrypting access to digital assets, without storing sensitive security data for decryption. One of ordinary skill in the art will recognize many alternative embodiments that are not explicitly listed based on the following disclosure.

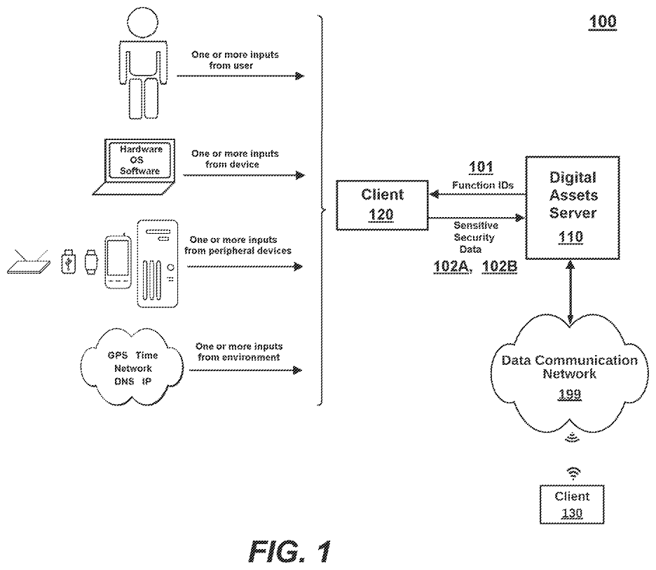

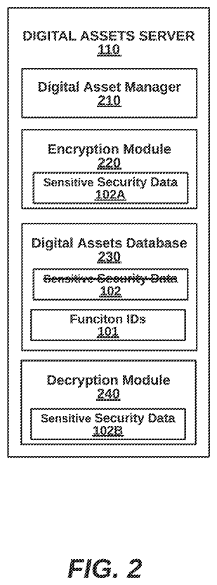

I. Systems for Encryption/Decryption without Storing Sensitive Security Data (FIGS. 1-2)

FIG. 1 is a high-level block diagram illustrating a system 100 for encrypting access to digital assets, without storing sensitive security data for decryption, according to one embodiment. The system 100 includes a digital asset server 110 and client 120, coupled in communication with a data communication network 199. Other embodiments of the system 100 can include additional network components that are not shown in FIG. 1. For example, there can be network devices such as switches, routers, fire walls, proxy servers, network gateways, network managers, and the like. Many other variations are possible.

The components of the system 100 are coupled in communication over the data communication network. The components can be connected to the data communication system via hard wire (e.g., digital asset server 110, client 120). The components can also be connected via wireless networking (e.g., client 120, client 130). The data communication network 199 can be composed of any data communication network such as an SDWAN, an SDN (Software Defined Network), WAN, a LAN, WLAN, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802.11r, and the like. Components can use IPv4 or IPv6 address spaces.

A digital asset, as referred to herein, can be a digital file, an account leading to digital files, an online service, a digital streaming, a crypto wallet, a login, or the like. For example, access to a bank account may require preconfigured or random collection or real-time data at the client 120 for decrypting login credentials, which upon unlocking, automatically display the bank account dashboard. In another example, a user selects a photo thumbnail for downloading from an online archive, triggering real-time data collection. In yet another example, a user needs access to a secure room or deposit box which unlocks upon successful decryption from real-time data collection.

In operation, the digital asset server 110 encrypts and decrypts digital assets, by collecting sensitive security data in real-time. For encrypting, sensitive security data is collected and then destroyed when storing the encrypted digital assets. When subsequent access is needed, new sensitive security data is collected in real-time for decryption. Thus, sensitive security data collected at a time of encryption needs to match sensitive security data collected at a time of decryption for success, in some implementations. In one case, the digital assets server 110 initiates the process upon request or storing or retrieving digital assets. In another case, the client 120 can decide on inputs and collect data passed onto the digital assets server 110 for processing.

In more detail, an example of sources for sensitive security data is shown as being sourced from a group of functions, also be referred to as gestures. A function can be, without limitation, a function name, a function ID, a URL, a programming language interface, a programming language pointer, a callback, a database record with a function body. The function types of system 100 include user facing functions 121, device detection functions 122, peripheral communication functions 123, and physical and network detection functions 124.

The user facing functions 121 can be biological data such as fingerprints, retina scanning, voice recognition, head recognition, and the like. The device detection functions 122 can be hardware configuration of a computer, an operating system type and version, a list of installed software applications, and other aspects of the direct computing environment. Similarly, the peripheral communication functions 123 is sourced from indirectly connected computer devices, such as smart phones, network switches, printers, and other wired or wireless devices. Finally, physical and network detection functions 124 can involve GPS location, DNS data, IP address, and other factors. Of course, these are non-limiting examples and non-limiting combinations for sourcing sensitive security data. Some implementations require only two inputs while other more valuable digital assets can require four or five inputs. For flexibility, the requirement can be inputs from two or three function types, as determined by reliability, accuracy, or the like.

The client 120 is directly connected to the digital assets server 110, while the client 130 is indirectly connected over a network. A direct connection may be used for digital access to local locks protecting a room or lockbox, or for digital access to physical assets such as an IoT (Internet of Things) device like a front door to a house. An indirect connection may be used for online assets, for accessibility from any Internet connection. In one implementation, a daemon, app, or operating system patch is downloaded for communication with the digital assets server 110. In another implementation, no pre-configuration is needed, and an Internet browser, operating system and other existing software is leveraged for operation.

In one case, a user stores a digital asset using the client 120 and retrieves the digital asset using the client 130. The gestures required for access would need to support different locations. The GPS gesture could not be used, unless configured for multiple locations. However, a peripheral connection gesture can be used if the same smart phone is connected to the client 130 during decryption as was connected to the client 120 during encryption.

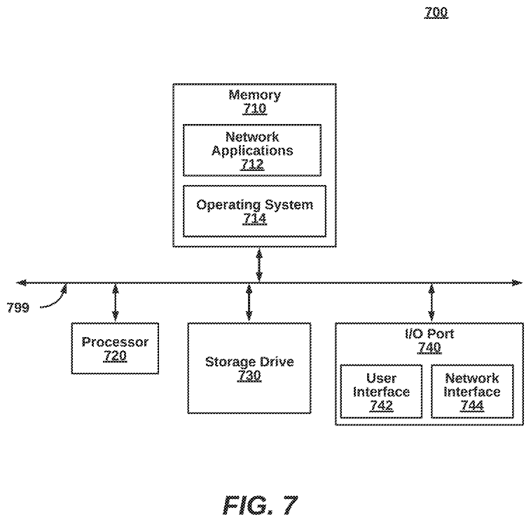

The clients 120, 130 can be implemented as, for example, a mobile station, a STA, a client or a wireless device, a personal computer, a laptop, a tablet computer, a smart phone, a mobile computing device, Internet access applications, an end station or any other computing device as described in FIG. 7. The client 120 can be connected by USB, Bluetooth or other peripheral connectors. The client 130 is wirelessly coupled to an access point or other network device using a radio and antenna. The clients 130A-C can operate according to wireless standards such as IEEE 802.11a, b, g, n, ac, w or any other wireless standard.

FIG. 2 is a more detailed block diagram illustrating the digital asset server 110 of the system 100 of FIG. 1, according to one embodiment. The digital asset server 110 includes a digital asset manager 210, an encryption module 220, a digital asset database 230, and a decryption module 240. The components can be implemented in hardware, software, or a combination of both.

The digital asset manager 210 (or controller), in one embodiment, receives a request to protect a digital asset. In general, the digital asset manager 210 can be an interface with users or processes storing and retrieving/accessing digital assets. At a later point in time, the digital asset manager 210 receives a request for access to the same digital asset. During access, the file can be edited, duplicated, deleted, or removed.

The encryption module 220 first creates an encryption key from sensitive security data sourced from one or more functions. The sensitive security data is live data retrieved in real-time from a user context. The function describes a live data requirement used to construct the encryption key. The digital asset is then encrypted with the encryption key, from the sensitive security data.

The digital asset database 230 stores the specific digital asset, as encrypted, and along with multiple other encrypted digital assets. The digital assets can all belong to a single entity or user, or can belong to multiple different users having different secure user accounts. The encryption key with the sensitive security data is deleted. Instead, one or more indicators of the one or more functions related to the encryption key are stored in association with the digital asset, without any of the sensitive security data being stored. Consequently, in the case of hacking, the encrypted digital asset will be extremely difficult to decrypt.

The decryption module 240, at a subsequently time, provides access to the digital asset. A decryption key with current sensitive data is created using the one or more indicators of the one or more functions to obtain a current instance of live data in real-time from a current user context. Finally, the digital asset is decrypted with the decryption key, from current sensitive data, for access to the digital asset. The decryption key with the sensitive security data can also be deleted to preserve high security.

The encryption module 220 can reencrypt the digital asset after access is completed. A reencrytion key is generated using live data collected in real time. A client uses function IDs to request various data combined as sensitive security data. The various data can be palm print, a hand gesture and an operating system type, for example. The specific functions collected for reencryption can be different in some embodiments, and kept the same in other embodiments. The reencryption process can be responsive to a time out, closing a digital file, user request, 3rd party server request, and other triggers.

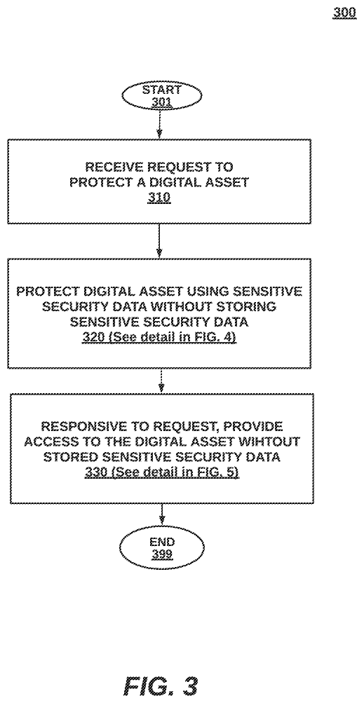

II. Methods for Encryption/Decryption without Storing Sensitive Security Data (FIGS. 3-6)

FIG. 3 is a high-level flow diagram illustrating a method 300 for protecting access to digital assets, according to an embodiment. The method 300 can be implemented by, for example, the digital assets server 110 of FIG. 1.

At step 310, a request is received to protect a digital asset. The request can be from a process or a user over a user interface, for instance. Also, the request can be local or over the Internet. A specific user account can be indicated in the request, for storing a map of digital assets in long term memory for the user.

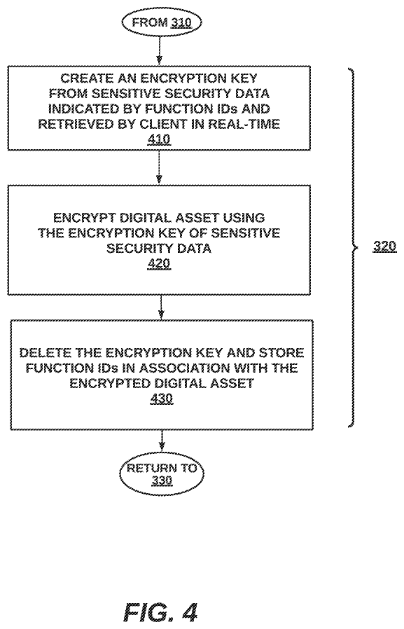

At step 320, a digital asset is protected using sensitive security data without storing sensitive security data, as discussed further below with regards to FIG. 4.

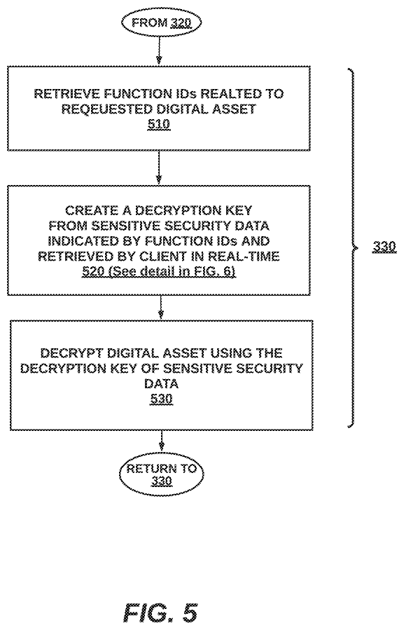

At step 330, a request for access to the digital asset is received. In response, access is provided to the digital asset without the need of any sensitive security data being saved. For example, a typical fingerprint protection scheme saves a copy of the fingerprint for later comparison, thus saving sensitive security data. Additional details for the decryption step 330 are set forth below with respect to FIG. 5.

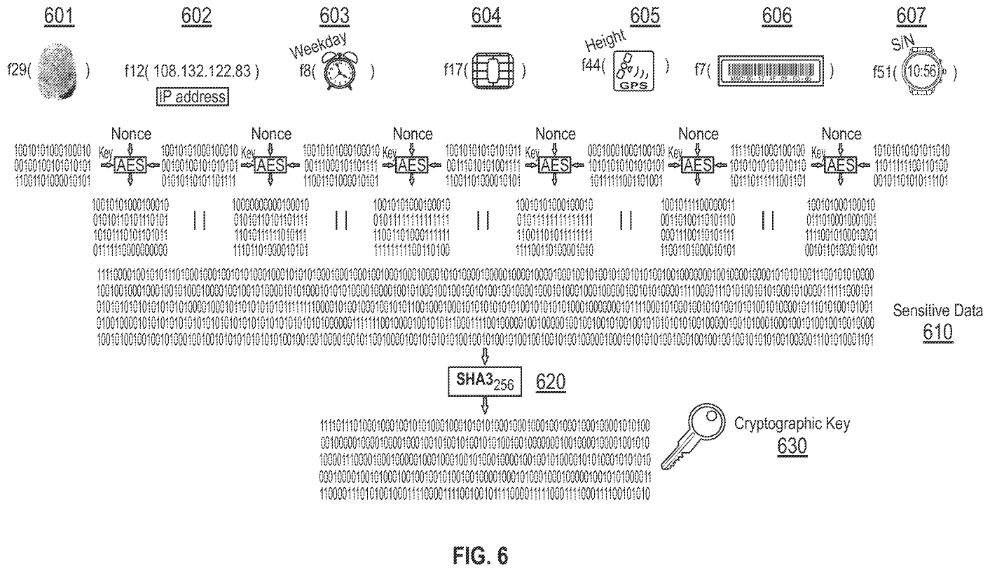

Turning now to FIGS. 4 and 5, further details are provided for the encryption step 320 and the decryption step 330. First, at step 410, an encryption key is created from sensitive security data for encryption. In one instance, a specific set of functions are identified by a function ID, for collection at a client, such as fingerprint and MAC address of the user device. The real-time data is used to encode the digital asset. For example, FIG. 6 shows functions with live data 601-607. The sensitive security data 610 is processed to be input for an SHA3 module 620 to output cryptographic key 630.

At step 420, the digital asset is encrypted using the encryption key of sensitive security data. Rather than storing the encryption key, it is deleted, disabled, quarantined, trashed, or otherwise impaired from use by a hacker, at step 430. One or more indicators of the one or more functions related to creating the encryption key is stored in association with the digital asset, without any of the sensitive security data.

FIG. 5 details the decryption step 330, in one nonlimiting embodiment. At step 510, function IDs related to a requested assets are retrieved. A request can be sent to a client that is requesting access, to collect certain live data. The data collection is in real-time and based on a current user context. The same functions are used for encryption and decryption.

At step 520, a decryption key is created with current sensitive data collected, as shown in FIG. 6. As long as the current sensitive security data matches the original sensitive security data used for encryption, the new key will successfully decrypt the digital asset, at step 530. Matching tolerances are implementation-specific.

III. Computing Device for Encryption/Decryption without Storing Sensitive Security Data (FIG. 7)

FIG. 7 is a block diagram illustrating an example of a computing device 700 for use in the system 100 of FIG. 1, according to one embodiment. The computing device 700 is a device that is implementable for each of the components of the system 100 for encrypting access to digital assets, without storing sensitive security data for decryption. Each of the digital assets server 110, the client 120 and the client 130 can be implemented using the computing device 700. However, the computing device 700 is merely an example implementation itself, since the system 100 can also be fully or partially implemented with other computing devices, such as laptop computers, tablet computers, smart cell phones, Internet access applications, and the like.

The computing device 700 of the present embodiment, includes a memory 710, a processor 720, a hard drive 730, and an I/O port 740. Each of the components is coupled for electronic communication via a bus 799. Communication can be digital and/or analog, and use any suitable protocol.

The memory 710 further comprises network access applications 712 and an operating system 714. Network access applications 712 can include a web browser, a mobile access applications, an access applications that uses networking, a remote access applications executing locally, a network protocol access applications, a network management access applications, a network routing access applications, or the like.

The operating system 714 can be one of the Microsoft Windows® family of operating systems (e.g., Windows 98, Me, Windows NT, Windows 2000, Windows XP, Windows XP x64 Edition, Windows Vista, Windows CE, Windows Mobile, Windows 7-10), Android, Linux, HP-UX, UNIX, Sun OS, Solaris, Mac OS X, iOS, Alpha OS, AIX, IRIX32, or IRIX84. Other operating systems may be used. Microsoft Windows is a trademark of Microsoft Corporation.

The processor 720 can be a network processor (e.g., optimized for IEEE 802.11), a general purpose processor, an access applications-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 720 can be single core, multiple core, or include more than one processing elements. The processor 720 can be disposed on silicon or any other suitable material. The processor 720 can receive and execute instructions and data stored in the memory 710 or the hard drive 730.

The storage device 730 can be any non-volatile type of storage such as a magnetic disc, EEPROM, Flash, or the like. The storage device 730 stores code and data for access applications.

The I/O port 740 further comprises a user interface 642 and a network interface 744. The user interface 742 can output to a display device and receive input from, for example, a keyboard. The network interface 744 connects to a medium such as Ethernet or Wi-Fi for data input and output. In one embodiment, the network interface 744 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C #, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

I claim:

1. A method in a security device for protecting access to digital assets, without storing sensitive security data for decryption, the method comprising:
receiving a request to protect a digital asset;
creating an encryption key from sensitive security data sourced from one or more functions, wherein the sensitive security data is live data retrieved in real-time from a user context, and wherein a function describes a live data requirement;
encrypting the digital asset with the encryption key, from the sensitive security data, for storage;
deleting the encryption key with the sensitive security data and storing one or more indicators of the one or more functions related to the encryption key in association with the digital asset without any of the sensitive security data;
subsequently receiving a request for access to the digital asset;
creating a decryption key with current sensitive security data using the one or more indicators of the one or more functions to obtain a current instance of live data in real-time from a current user context; and
decrypting the digital asset with the decryption key, from current sensitive security data, for access to the digital asset.

2. The method of claim 1, wherein the encryption key comprises at least one of a password, a token, a cryptographic key, a resource ID, a device ID, an app ID, a nonce, and a challenge string.

3. The method of claim 1, further comprising:
deleting the decryption key with the sensitive security data.

4. The method of claim 1, further comprising:
providing access to the digital asset.

5. The method of claim 1, further comprising:
reencrypting the digital asset using a reencryption key generated from live data collected in real time; and
deleting the reencryption key.

6. The method of claim 1, wherein the digital asset comprises one or more of: a digital file, an account leading to a digital file, an online service, a data streaming packet, a crypto wallet, digital access to a physical object and login credentials.

7. The method of claim 1, wherein the functions comprises one or more of: user facing functions, device detection functions, peripheral communication functions, and network detection functions.

8. The method of claim 1, further comprising:
determining a set of functions for collection to encrypt the specific digital asset; and
receiving sensitive security data relating to the set of functions.

9. The method of claim 1, wherein the received request to protect the digital asset is received across a data communication network from a client device, and the sensitive security data from key encryption is also received from the client device.

10. The method of claim 1, wherein the live data comprises one or more of: a fingerprint, a retina scan, a voice sample, a user image, an operating system type, an operating system version, a list of installed applications, a peripheral smartphone, a peripheral network switch, a peripheral router, a GPS location, DNS data, and an IP address.

11. The method of claim 1, wherein indicators of functions comprises one or more of: a function name, a function ID, a URL, a programming language interface, a programming language pointer, a callback, and a database record with a function body.

12. A non-transitory computer-readable medium storing instructions that, when executed by a processor, perform a computer-implemented method for protecting access to digital assets, without storing sensitive security data for decryption, the method comprising:
receiving a request to protect a digital asset;
creating an encryption key from sensitive security data sourced from one or more functions, wherein the sensitive security data is live data retrieved in real-time from a user context, and wherein a function describes a live data requirement;
encrypting the digital asset with the encryption key, from the sensitive security data, for storage;
deleting the encryption key with the sensitive security data and storing one or more indicators of the one or more functions related to the encryption key in association with the digital asset without any of the sensitive security data;
subsequently receiving a request for access to the digital asset;
creating a decryption key with current sensitive security data using the one or more indicators of the one or more functions to obtain a current instance of live data in real-time from a current user context; and
decrypting the digital asset with the decryption key, from current sensitive security data, for access to the digital asset.

13. A digital assets server to protect access to digital assets, without storing sensitive security data for decryption, the digital assets server comprising:
a processor;
a network interface communicatively coupled to the processor and to the hybrid wireless network; and
a memory, communicatively coupled to the processor and storing:
a monitoring module to receive a request to protect a digital asset;
an encryption module to create an encryption key from sensitive security data sourced from one or more functions, wherein the sensitive security data is live data retrieved in real-time from a user context, and wherein a function describes a live data requirement, the encryption module to encrypt the digital asset with the encryption key, from the sensitive security data, for storage,
wherein the encryption module deletes the encryption key with the sensitive security data and storing one or more indicators of the one or more functions related to the encryption key in association with the digital asset without any of the sensitive security data,
wherein the monitoring module subsequently receives a request for access to the digital asset; and
a decryption module to create a decryption key with current sensitive security data using the one or more indicators of the one or more functions to obtain a current instance of live data in real-time from a current user context, the decryption module to decrypt the digital asset with the decryption key, from current sensitive security data, for access to the digital asset.
